(19) United States
(12) Patent Application Publication
(10) Pub. No.: US 2004/0071927 A1
(43) Pub. Date: Apr. 15, 2004

(54) Liquid impermeable barrier

(76) Inventors: Peter Michael Murphy, Ooltewah, TN (US); James Thomas Summers, Hendersonville, TN (US); Prentice Lee Huffines, Old Hickory, TN (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/677,901

(22) Filed: Oct. 2, 2003

Related U.S. Application Data
(62) Division of application No. 09/669,477, filed on Sep. 25, 2000.

(51) Int. Cl. B32B 33/00; B32B 27/12

(52) U.S. Cl. 428/95; 442/286; 442/394

(57) ABSTRACT

A carpet underlay comprising a composite of a fibrous substrate and a film affixed to said substrate which is impermeable to liquids and permeable to moisture vapor is disclosed.

### BACKGROUND OF THE INVENTION

Water resistant carpet underlays provide a way to clean spills on carpet more thoroughly by helping to contain the spill above the padding or floor. If a spill is not removed from under the carpet, the spill will allow the growth of mold, mildew, and bacteria. Not only may the padding and wood flooring deteriorate as a result, but such conditions are conducive to the formation of odors and allergens. Spills on fitted or wall-to-wall carpeting are particularly insidious since detection and prevention of the seepage into the padding following a spill is typically impractical with large or fitted carpets. A spill on broadloom carpeting often puddles on the padding or flooring where it can not be removed by cleaning. This spill then accelerates the growth of mold, mildew and odors.

Murphy, in U.S. Pat. Nos. 5,601,910 and 5,763,040, described processes for chemically treating an underlay with a repellent finish to make it substantially impermeable to spills. By careful selection of both the water repellent finish and adhesive, the underlay was adhered to the underside of the carpet creating a barrier substantially impervious to spills.

The prior art also describes water impermeable carpeting constructed using sheets of plastic, such as polyethylene and poly(ethylene/vinyl acetate), that are laminated to the carpet. However, such backings are expensive, create manufacturing difficulties, and prevent desirable breathability (air permeability) of the carpet. Thus the growth of mold and mildew are not prevented.

Following a spill, the well-intentioned but perhaps distraught homeowner will frequently lay paper towels or other absorbent material on the spill and stamp or otherwise apply an excessive downward force on the spill area, rather than just gently absorbing the spill. Stamping on the spill or on absorbent material laid over the spill can force liquid through water repellent underlays of the prior art. While the nonbreathable thermoplastic films such as poly(ethylene) are sufficiently impermeable to resist the application of the homeowner's weight, such underlays as a fluorocarbon-treated non-woven fabric will allow moisture to pass through when excessive weight is applied.

It would be advantageous if an improved underlay material could be fabricated that would maintain its water impermeability even when spills are absorbed by stamping on an absorbent material laid over the spill. It is also desirable that the underlay is air permeable so that moisture is not trapped beneath it leading to mold and mildew. The present invention provides such an improved underlay having liquid impermeability while maintaining vapor breathability.

### SUMMARY OF THE INVENTION

The present invention comprises a carpet underlay comprising a composite of a fibrous substrate having opposite first and second planar sides, and at least one film affixed to the first side of said substrate, said underlay impermeable to liquids and permeable to moisture vapor.

The present invention further comprises a carpet underlay comprising a composite of a fibrous substrate, an optional control layer affixed to said substrate, a tie layer affixed to said control layer or to said substrate, and a moisture vapor permeable film affixed to said tie layer, said underlay impermeable to liquids and differentially permeable to moisture vapor.

The present invention further comprises a tufted pile carpet comprising: a) a primary backing having a surface tufted with pile yarns and an underside to which a latex has been applied; b) an optional secondary backing having a surface and an underside, wherein the surface of the secondary backing is adhered to the underside of the primary backing; and c) an underlay of the present invention as described above adjacent to or affixed to the primary or secondary backing.

The present invention further comprises a carpet cushion of a material providing resiliency, support, or noise reduction having opposite first and second planar sides and having adjacent to or affixed to one of said sides an underlay of the present invention as described above.

The present invention further comprises a process for rendering a carpet or a carpet cushion impermeable to liquids and permeable to moisture vapor comprising placing adjacent to or affixing to an underside of said carpet or said carpet cushion an underlay of the present invention as described above.

### DETAILED DESCRIPTION OF THE INVENTION

The present invention comprises a carpet underlay comprising a composite of a fibrous substrate having opposite first and second planar sides, and at least one film affixed to the first side of said substrate, said underlay exhibiting impermeability to liquids and permeability to moisture vapor. The film is formed from a polymeric material that is impermeable to liquids but through which water vapor can readily permeate. Important attributes of the underlay or impermeable barrier for carpets provided by the present invention are (1) the ability to keep the underlying carpet pad and floor dry under a wide range of spills and cleaning techniques, and (2) the ability to prevent the retention of trapped moisture under the barrier by allowing it to evaporate promptly.

The term “breathable liquid-impermeable underlay” is used hereinafter to describe such composites comprising a fibrous substrate affixed to a film formed from a polymeric material that is impermeable to liquids but through which moisture vapor can readily permeate.

The term “breathable” denotes a moisture vapor transport rate of 100 g/m²/day or more, determined by Test Method 2 described below.

The terms “permeable”, “vapor breathability”, and “air permeability” are used interchangeably with “breathable” herein.

The term “impermeable” signifies a “dry” rating under the conditions of Test Method 1 described below.

The term “carpet cushion” as defined by The Carpet and Rug Institute (CRI), located in Dalton Ga., means any kind of material placed under carpet to provide resiliency, support, and noise reduction when walked upon (CRI 105 “Residential Carpet Installation Standards”).

The term “padding” or “pad” is considered synonymous with “carpet cushion”.

Trademarks and tradenames are indicated by capitalization herein.

The invention provides a moisture vapor permeable, liquid impermeable composite comprising a fibrous substrate and at least one film. The composite is a laminate or a coating product and is free of pinholes or pores. As used herein, pinholes means small holes inadvertently formed in the film, while pores means small holes formed intentionally to enhance porosity to air, moisture, vapor, or liquids.

The fibrous substrate component of the breathable liquid-impermeable underlay is any woven or non-woven fabric or web, and is preferably a light non-woven fabric, selected from the group consisting of polyester, polyolefin, polyamide, poly(trimethylene terephthalate) synthetic fibers, natural fibers, bicomponent fibers, cellulosic fibers, wool, cotton, acrylic, jute, and copolymers and blends thereof. By the term “cellulosic” is meant fibrous cellulose-based products made from wood or other plants. Bicomponent fibers include fibers made of two polymers, blends of polymeric fibers with natural or synthetic fibers, and blends of natural and synthetic fibers. Suitable nonwoven materials include spunbonded webs, scrims, carded webs, flashspun webs, or nonwoven sheets comprised of blends of polymer fibers. Preferred are underlays wherein the fibrous substrate is a polyester spun-laced nonwoven fabric.

Particularly preferred are nonwoven fabrics such as SONTARA, a spun-laced nonwoven fabric available from E. I. du Pont de Nemours and Company, Wilmington Del. SONTARA is a spunlaced fabric formed by a hydroentangling process in which staple fibers are entangled through “hydraulic needling” to form a strong, fabric-like structure. SONTARA consists of fibers and/or wood pulp entangled in predetermined, repeating patterns forming strong structures without binder and having tensile strength greater than one pound per inch of fabric width for each ounce per square yard (5.3 g per cm fabric width for each g/m²). The manufacture of SONTARA is described in U.S. Pat. Nos. 3,797,074 and 3,485,706, herein incorporated by reference.

The film component of the breathable liquid-impermeable underlay is any solid and void- and pore-free polymeric film through which water molecules may readily diffuse. The film is impermeable to liquids, and permeable to moisture vapor. It is typically a thermoplastic or thermoset polymer material that can be coated or extruded or laminated. Suitable polymers include vulcanized silicone rubbers, silicone polymers, polyurethanes, polyether esters, polyether amides, polyurethane esters, polyurethane ethers, polyvinyl alcohol, and copolymers and blends thereof. Particularly preferred are films of HYTREL, a butylene/poly(alkylene ether) phthalate copolymer available from E. I. du Pont de Nemours and Company, Wilmington Del.

Also suitable for use in this invention are film components wherein either (a) the film has a first layer and second layer, each of said layers being comprised of a different moisture vapor permeable polymer composition, or (b) the film has one hydrophilic layer and one hydrophobic layer. Such films having a bicomponent structure are described in U.S. Pat. No. 4,725,481, herein incorporated by reference. Use of a bicomponent film of a hydrophilic layer and a hydrophobic layer bonded together permits differential transfer of moisture vapor to prevent buildup of moisture. This is because the bicomponent film has a separation ratio for water vapor of at least about 1.2 as determined by ASTM E-96-66 (Procedure BW). The separation ratio for water vapor is described by the ASTM method as the value of the water vapor transmission rate measured with the hydrophilic layer of the film next to the water surface divided by the value of the water vapor transmission rate of the film with the hydrophobic layer next to the water surface. Generally the film has a higher water vapor transmission rate when water vapor passes in the direction of the hydrophilic layer of film and then through the hydrophobic layer. Thus in the underlay of the present invention, placement of the hydrophilic layer of film next to the floor or the padding results in a reduction of accumulation of moisture vapor between the underlay and the floor or padding due to the higher rate of transmission from the hydrophilic layer through the hydrophobic layer. The water vapor transmission rates of the hydrophilic and hydrophobic layers can be regulated by the thickness of the layer and the chemical composition of the layer.

A second embodiment of the present invention comprises a breathable liquid-impermeable underlay comprising a composite of a fibrous substrate, an optional control layer affixed to said substrate, a tie layer affixed to said control layer or to said substrate, and a moisture vapor permeable film affixed to said tie layer, said underlay exhibiting impermeability to liquids and differential permeability to moisture vapor. In this embodiment an optional control layer is positioned between the fibrous substrate and a tie layer. This control layer acts as a vapor control layer. Preferably, the optional control layer is a polymer capable of reducing the moisture vapor transmission rate of the composite. The control layer is selected from the group consisting of polyethylene, polypropylene or a copolymer thereof. In this embodiment, a tie layer is present between the fibrous substrate or optional control layer and the moisture vapor impermeable film. The tie layer functions to improve adhesion to the fibrous substrate. The tie layer is capable of compatabilizing the fibrous substrate or control layer and the film layer and forms a strong bond with both. It also works in combination with the moisture vapor impermeable film to enable the composite to exhibit differential permeability. The tie layer can also comprise further additives known in the art. Preferably the tie layer is a copolymer of ethylene co-monomer units and vinyl acetate co-monomer units. Structure of such control layer, tie layer, and moisture vapor permeable layer are described in patent application, U.S. Ser. No. 60/158,786 (docket number AD-6649-P1) herein incorporated by reference.

The composite of the second embodiment is capable of exhibiting differential permeability. The moisture vapor transmission rate in one direction through the layers of the composite is greater than that in the opposite direction. The moisture vapor transmission rate in the direction away from the film layer and tie layer and towards the fibrous substrate layer is greater than the moisture vapor transmission rate in the direction away from the substrate layer and towards the tie layer and film layer. The moisture vapor transmission rate of each layer is primarily dependent upon the chemical composition of the layer and the thickness of the layer. These parameters can be adjusted to optimize performance.

The composites of the present invention are prepared by lamination or coating techniques. The film is laminated to or coated on the fibrous substrate by any of various methods well known to those skilled in the art in an amount sufficient to provide liquid impermeability and a moisture vapor transport rate (MVTR) of at least 100 g/m²/day. Such methods include the use of adhesives (adhesive lamination), heat bonds (thermal lamination), pressure bonding, ultrasonic bonding, dynamic mechanical bonding, and extrusion coating, or any other suitable attachment means, or combinations of these attachment means.

Processes for the extrusion melt coating of a polymer resin onto non-woven or other substrates are well known. The process generally involves the steps of heating the polymer to a temperature above its melting point, extruding it through a flat die onto a substrate which passes through the curtain of molten polymer, subjecting the coated substrate to pressure to effect adhesion, and then cooling. The extrusion melt coating method is widely used since it allows economical production of a laminated structure in a one-step procedure.

Conveniently, formation of the laminate structure of the invention, optionally including the control layer, is effected by coextrusion of the respective layers onto the substrate, either by simultaneous coextrusion of the respective layers through independent orifices of a multi-orifice die, and thereafter uniting the still molten layers, or, preferably, by single-channel coextrusion in which molten streams of the respective polymers are first united within a channel leading to a die manifold, and thereafter extruded together from the die orifice under conditions of streamline flow without intermixing onto the substrate.

Conventional laminating techniques may also be used, for example by lamination of a preformed film layer and a preformed tie layer, or a preformed film layer, a preformed tie layer and a preformed control layer, either before or simultaneously with lamination thereof with the substrate, or by casting. Typically, such lamination techniques would involve thermal lamination of the respective layers on hot roll calendering equipment, wherein the temperature used to bond the layers to the substrate is sufficient to effect melting or softening of one or more layers, and with the application of sufficient pressure, the layers become bonded.

Preferably, the process is an extrusion coating process wherein the tie layer is coextruded with said film layer, or, if the control layer is included, wherein the control layer, the tie layer, and the film layer are coextruded together. Minimum film thickness can be less than 1 mil (25 μm). The moisture vapor permeable film is substantially free of pinholes or pores. Extrusion coating a thin layer of the film onto the fibrous substrate is a preferred manufacturing technique.

The breathable liquid-impermeable underlays of this invention are used alone, underneath but not attached to an overlying carpet, underneath and attached to an overlying carpet, underneath an overlying carpet and attached to padding, or any combination thereof.

The breathable liquid-impermeable underlays of the present invention show improved liquid impermeability, especially impermeability to liquids under pressure, such liquids as water, hot and cold beverages, oils, detergent solutions, and alcohols. For example, a film of HYTREL laminated to a SONTARA non-woven fabric provides better liquid impermeability than SONTARA treated with a water repellant while maintaining a high moisture vapor transport rate. The fibrous substrate provides the strength and dimensional stability at a lower cost than an equal strength film of the HYTREL alone, which provides the liquid impermeability. The breathable liquid-impermeable underlay is laid with the film layer on top or underneath, and preferably with the film on top. The breathable liquid-impermeable underlay is laid under the carpet either unattached to the carpet, or affixed to the carpet or affixed to the padding by any conventional method that does not involve puncturing the underlay.

The present invention further comprises a tufted pile carpet comprising:

a) a primary backing having a surface tufted with pile yarn and an underside to which a latex has been applied;

b) an optional secondary backing having a surface and an underside, wherein the surface of the secondary backing is adhered to the underside of the primary backing; and

c) an underlay of the present invention as previously described.

An underlay of the present invention described above is laid below, or optionally affixed to, the underside of the carpet by an adhesive applied to the upper side of the underlay. Alternatively the underlay is treated with adhesive on both sides to attach it to both the underside of the carpet and the padding. Such attachment prevents movement of the underlay as the carpet is laid, and also prevents any movement due to traffic after the installation is complete, but liquid impermeability of the barrier does not require attachment.

The present invention further comprises a carpet cushion of a material providing resiliency, support, or noise reduction having opposite first and second planar sides and having adjacent to or affixed to one side an underlay of the present invention as described above. The optional attachment of the underlay to either surface of the cushion using conventional adhesion techniques.

The present invention further comprises a process for rendering carpet or carpet cushion impermeable to liquids and permeable to moisture vapor comprising placing adjacent to or affixing to a surface of said carpet or cushion an underlay of the present invention as described above.

The underlay of the present invention is useful to provide an impermeable barrier between a carpet and carpet cushion, between a carpet and floor, or between a carpet cushion and floor. Thus the floor and carpet cushion remain dry under a wide variety of spills and cleaning techniques. The underlay also prevents retention of any trapped moisture by allowing evaporation. This prevents damage to the carpet cushion and floor and prevents the formation of mold and mildew.

### TEST METHODS

### Test Method 1. Water Impermeability

A 5-layer test stack was prepared as follows: (1) A sample of residential carpeting with water permeable, latex was placed over (2) the underlay sample which was in turn placed on (3) a white absorbent paper towel placed over (4) rebond carpet padding which was placed over (5) a wood particle board sheet.

The paper towels used were single-fold paper towels available from Kimberly-Clark, Dallas Tex. Since the test requires no visible wetness of the towel, the choice of paper towel is not critical and other thin absorbent media, such as Whatman No.1 Filter paper may be substituted. A colored aqueous solution may be used to aid visual detection. Then 100 ml of water, at a room temperature of 24±3° C. (75±5° F.) was slowly poured onto the carpet sample through a cylinder of about 8 cm diameter and from a height of about 1 meter to create a circular puddle. The cylinder was removed and the sample was left undisturbed for 20 minutes. For the 0 psi (0 kPa, i.e. spill only test) the carpet and underlay were removed. If any water spot was visible on the towel (designated “wet” in the results), then the underlay was judged a failure to provide sufficient water impermeability to a water spill. If the paper towel between the padding and carpet was dry (designated “dry” in the results), the underlay was judged acceptable and provided sufficient water impermeability to a water spill. Alternatively, the water was “blotted” from the carpet pile with dry paper towels at a given pressure. After ten “blottings” with the given pressure, the carpet and underlay were removed. If any water spot was visible on the towel, then the underlay was judged a failure (or “wet”) and did not provide sufficient water impermeability for a water spill followed by blotting at the given pressure. If the paper towel between the padding and carpet was “dry”, the underlay was judged to provide sufficient water impermeability for a water spill followed by blotting at the given pressure. Blotting pressures of 0, 3, 8, 16, and 33 psi (0, 21, 55, 110, and 227 kPa) were utilized. A blotting pressure of 33 psi or 228 kPa exceeds the pressure exerted by a typical homeowner standing on a paper towel to accelerate the blotting of a spill. After a “wet” or fail rating, tests at higher blotting pressures were not made (denoted by “X” in Table 1). The blotting pressures were created by placing weights on a circular disc as follows:

| Total weight of | | Resulting |
|---|---|---|
| plate and | Plate diam. | pressure |
| weights [lb (kg)] | [in² (cm²)] | [psi (kPa)] |
| 42 (19) | 14 (90) | 3 (21) |
| 110 (50) | 14 (90) | 8 (55) |
| 220 (100) | 14 (90) | 16 (110) |
| 220 (100) | 6.7 (43) | 33 (228) |

### Test Method 2. Moisture Vapor Transport Rate.

The Moisture Vapor Transport Rate (MVTR) is measured in an “up cup” configuration, over a saturated head of water vapor according to the procedure described the American Society for Testing Materials (ASTM) Standard ASTM E96-92, herein incorporated by reference.

### EXAMPLES

In the following examples, all carpet samples were purchased commercially from Carpets of Dalton, Dalton, Ga. Sources of other materials are listed after Table 1.

### Examples 1, 2, 3

HYTREL 4778 was fed to a 1.5-inch (3.8 cm) diameter extruder connected to a melt combining block, heated to about 225° C., and extruded at 25 rpm. The molten HYTREL 4778 then passed through a die connected to the combining block having a 35 inch (89 cm) wide die block heated to about 225° C. A film was formed exiting from the die that had a thickness of 1 mil (25 μm). The film exiting from the die was coated on a nonwoven lightweight scrim fabric of spun bonded polyethylene terephthalate (SONTARA 8000) as a substrate. The underlay was tested according to Test Methods 1 and 2 using the following carpets: 1) 28 oz/yd² (950 g/m²) Berber level loop polypropylene carpet, 2) 42 oz/yd² (1425 g/m²) nylon cut-pile carpet, and 3) 65 oz/yd² (2200 g/m²) nylon cut-pile carpet. The results are shown in Table 1 as Examples 1, 2 and 3 respectively.

### Examples 4, 5, 6

HYTREL 8206 was fed to a 1.5 inch (3.8 cm) diameter extruder connected to a melt combining block. HYTREL 4778 was fed to a 1 inch (2.5 cm) diameter extruder that was also connected to the same melt combining block. The HYTREL 8206 was heated to about 225° C. and coextruded at 20 rpm and the HYTREL 4778 was heated to about 225° C. and coextruded at 10 rpm to the melt combining block connected to the extruders. The coextruded layers were combined in the melt block. The layers were then passed through a die connected to the combining block having a 35 inch (89 cm) wide die block heated to about 225° C. A bonded bicomponent film was formed exiting from the die that had a combined thickness of 1 mil (25 μm). The HYTREL 8206 was 0.8 mil (20 μm) thick, and the HYTREL 4778 was 0.2 mil (5 μm) thick. The bicomponent film exiting from the die was coated on a nonwoven lightweight scrim fabric of spun bonded polyethylene terephthalate (SONTARA 8000) as a substrate with the HYTREL 8206 layer next to the scrim fabric. The underlay was tested according to Test Methods 1 and 2 using the following carpets: 1) 28 oz/yd² (950 g/m²) Berber level loop polypropylene carpet, 2) 42 oz/yd² (1425 g/m²) nylon cut-pile carpet, and 3) 65 oz/yd² (2200 g/m²) nylon cut-pile carpet. The results are shown in Table 1 as Examples 4, 5 and 6 respectively.

### Examples 7, 8, 9

These extrusion coated fabrics were made according to the procedure in Example 4, with the exception that the polymer extruder rpm and die thickness resulted in a film thickness of 0.6 mil (15 μm). The underlay was tested according to Test Methods 1 and 2 using the following carpets: 1) 28 oz/yd² (950 g/m²) Berber level loop polypropylene carpet, 2) 42 oz/yd² (1425 g/m²) nylon cut-pile carpet, and 3) 65 oz/yd² (2200 g/m²) nylon cut-pile carpet. The results are shown in Table 1 as Examples 7, 8 and 9 respectively.

### Examples 10, 11, 12

These extrusion coated fabrics were made according to the procedure in Example 1 except that the fabric substrate was SONTARA 8004. The underlay was tested according to Test Methods 1 and 2 using the following carpets: 1) 28 oz/yd² (950 g/m²) Berber level loop polypropylene carpet, 2) 42 oz/yd² (1425 g/m²) nylon cut-pile carpet, and 3) 65 oz/yd² (2200 g/m²) nylon cut-pile carpet. The results are shown in Table 1 as Examples 10, 11 and 12 respectively.

### Examples 13, 14 and 15

These extrusion coated fabrics were made according to the procedure in Example 1 except that HYTREL blend P18-3892 was substituted for HYTREL 4778 and the fabric substrate was HDK powder bonded nonwoven. The underlay was tested according to Test Methods 1 and 2 using the following carpets: 1) 28 oz/yd² (950 g/m²) Berber level loop polypropylene carpet, 2) 42 oz/yd² (1425 g/m²) nylon cut-pile carpet, and 3) 65 oz/yd² (2200 g/m²) nylon cut-pile carpet. The results are shown in Table 1 as Examples 13, 14 and 15 respectively.

### Example 16

KC MICROCOOL laminate nonwoven fabric (described in the footnotes to Table 1 below) was used as purchased as the underlay and tested according to Test Methods 1 and 2 using a 28 oz/yd² (950 g/m²) Berber level loop polypropylene carpet. The results are shown in Table 1.

### Examples 17 and 18

HYTREL G4778, a polyether-ester block copolymer, was dried and fed into an extrusion hopper. A 1.5-inch (3.8 cm) diameter extruder connected to a 14-inch (35.6 cm) coat hanger die block was heated up to 220° C. The molten polymer was extruded at 20 rpm. The film formed from the die was deposited onto a 0.9 oz/yd² (31 g/m²) spunbonded polyester (SBPET) nonwoven fabric between nip and casting rolls. The nip and casting roll temperatures were 28° C. The nip roll pressure was 80 psi (550 kPa). The film thickness was controlled by the coating line speed. The Example 17 sample having a 0.8 mil (20 μm) film thickness was produced by a line speed of 60 feet per minute (18.3 meters per minute). The line speed for the Example 18 sample was 42 feet per minute (12.8 meters per minute) which produced a 1.0 mil (25 μm) film thickness. The underlays were tested according to Test Methods 1 and 2 using a 28 oz/yd² (950 g/m²) Berber level loop polypropylene carpet. The results are shown in Table 1.

### Examples 19 and 20

HYTREL G4778 (a polyether-ester block copolymer) was dried and fed into an extrusion hopper. A 1.5-inch (3.8 cm) diameter extruder connected to a 14-inch (35.6 cm) coat hanger die block was heated up to 220° C. The molten polymer was extruded at 20 rpm. The film formed from the die was deposited onto a 0.5 oz/yd² (17 g/m²) spunbonded polyester (SBPP) nonwoven fabric between nip and casting rolls. The nip and casting roll temperatures were 28° C. The nip roll pressure was 80 psi (550 kPa). The film thickness was controlled by the coating line speed. The line speed for the Example 19 sample was 42 feet per minute (12.8 meters per minute) which produced a 1.0 mil (25 μm) film thickness. The Example 20 sample having a 0.8 mil (20 μm) film thickness was produced by a line speed of 60 feet per minute (18.3 meters per minute). The underlays were tested according to Test Methods 1 and 2 using a 28 oz/yd² (950 g/m²) Berber level loop polypropylene carpet. The results are shown in Table 1.

### Examples 21 and 22

HYTREL G4778 (a polyether-ester block copolymer) and BYNEL 50E631 (an anhydride-modified polypropylene resin) were dried and fed into an extrusion hopper at a weight ratio of 87% HYTREL and 13% BYNEL. A 1.5-inch (3.8 cm) diameter extruder connected to a 14-inch (35.6 cm) coat hanger die block was heated up to 220° C. The molten polymer was extruded at 20 rpm. The film formed from the die was deposited onto a 0.5 oz/yd² (17 g/m²) spunbonded polypropylene (SBPP) nonwoven fabric between nip and casting rolls. For Example 21 and 22 samples, the nip roll temperature was 80° C. and the casting roll temperature was 40° C. The nip roll pressure was 80 psi (550 kPa). The film thickness was controlled by the coating line speed. The line speed for the Example 22 sample was 42 feet per minute (12.8 meters per minute) which produced a 1.0 mil (25 μm) film thickness. The Example 21 sample having a 0.8 mil (20 μm) film thickness was produced by a line speed of 60 feet per minute (18.3 meters per minute). The underlays were tested according to Test Methods 1 and 2 using a 28 oz/yd² (950 g/m²) Berber level loop polypropylene carpet. The results are shown in Table 1.

TABLE 1
Impermeability Tests Results for Various Underlay Treatments.

| | | Spill | Paper Towel Appearance | | | | |
|---|---|---|---|---|---|---|---|
| | | Only | After 10 Blottings under | | | | |
| | | 0 | Pressure (b) | | | | |
| | | psi | 3 psi | 8 psi | 16 psi | 33 psi | |
| | Underlay Fabric/Underlay | 0 | 21 | 55 | 110 | 228 | MVTR(c) |
| Ex | Film (a) | kPa | kPa | kPa | kPa | kPa | g/m²/day |

(i) 28 oz/yds (950 g/m²) Berber, Level Loop Polypropylene Carpet
Comparative Examples:

| | | | | | | | |
|---|---|---|---|---|---|---|---|
| A | SONTARA 8827 treated with | dry | dry | wet | X | X | 1100 |
| | 3% fabric protector (d)/none | | | | | | |
| B | SONTARA 8827 treated with | dry | dry | dry | wet | X | 800 |
| | 4% fabric protector (d)/none | | | | | | |
| C | 4 mil (25 μm) polyethylene | dry | dry | dry | dry | dry | 0 |
| | film/none | | | | | | |
| D | W/H Housewrap/none | wet | X | X | X | X | 200 |
| E | O-C Housewrap/none | wet | X | X | X | X | 100 |
| F | TYVEK HomeWrap/none | dry | wet | X | X | X | 400 |

Examples:

| | | | | | | | |
|---|---|---|---|---|---|---|---|
| 1 | SONTARA 8000/1 mil (25 μm) | dry | dry | dry | dry | dry | 600 |
| | HYTREL 4778 | | | | | | |
| 4 | SONTARA 8000/1 mil (25 μm) | dry | dry | dry | dry | dry | 700 |
| | HYTREL CO-EX | | | | | | |
| 7 | SONTARA 8000/0.6 mil | dry | dry | dry | dry | dry | 800 |
| | (15 μm) HYTREL CO-EX | | | | | | |
| 10 | SONTARA 8004/1 mil (25 μm) | dry | dry | dry | dry | dry | 600 |
| | HYTREL 4778 | | | | | | |
| 13 | HDK/0.7 mil (18 μm) | dry | dry | dry | dry | dry | 600 |
| | HYTREL blend | | | | | | |
| 16 | KC MICROCOOL | dry | dry | dry | dry | dry | 350 |
| 17 | SBPET/0.8 mil (20 μm) | dry | dry | dry | dry | dry | 170 |
| | HYTREL G4778 | | | | | | |
| 18 | SBPET/1.0 mil (25 μm) | dry | dry | dry | dry | dry | 160 |
| | HYTREL G4778 | | | | | | |
| 19 | SBPP/1.0 mil (25 μm) | dry | dry | dry | dry | dry | 190 |
| | HYTREL G4778 | | | | | | |
| 20 | SBPP/0.8 mil (20 μm) | dry | dry | dry | dry | dry | 160 |
| | HYTREL G4778 | | | | | | |
| 21 | SBPP/0.8 mil (20 μm) | dry | dry | dry | dry | dry | 190 |
| | HYTREL G4778 (87%) & | | | | | | |
| | BYNEL 50E631 (13%) by | | | | | | |
| | Weight | | | | | | |
| 22 | SBPP/1.0 mil (25 μm) | dry | dry | dry | dry | dry | 200 |
| | HYTREL G4778 (87%) & | | | | | | |
| | BYNEL 50E631 (13%) by | | | | | | |
| | Weight | | | | | | |

(ii) 42 oz/yd² (1425 g/m²) Nylon Cut-Pile Carpet
Comparative Examples:

| | | | | | | | |
|---|---|---|---|---|---|---|---|
| G | SONTARA 8827 treated with | dry | dry | wet | X | X | 1100 |
| | a 3% fabric protector | | | | | | |
| | (d)/none | | | | | | |

Examples:

| | | | | | | | |
|---|---|---|---|---|---|---|---|
| 2 | SONTARA 8000/1 mil | dry | dry | dry | dry | dry | 600 |
| | (25 μm) HYTREL 4778 | | | | | | |
| 5 | SONTARA 8000/1 mil | dry | dry | dry | dry | dry | 700 |
| | (25 μm) HYTREL CO-EX | | | | | | |
| 8 | SONTARA 8000/0.6 mil | dry | dry | dry | dry | dry | 800 |
| | (15 μm) HYTREL CO-EX | | | | | | |
| 11 | SONTARA 8004/1 mil | dry | dry | dry | dry | dry | 600 |
| | (25 μm) HYTREL 4778 | | | | | | |
| 14 | HDK/0.7 mil (18 μm) | dry | dry | dry | dry | dry | 600 |
| | HYTREL blend | | | | | | |

(iii) 65 oz/yd² (2200 g/m²) Nylon Cut-Pile Carpet
Comparative Examples:

| | | | | | | | |
|---|---|---|---|---|---|---|---|
| H | SONTARA 8827 treated with | dry | dry | wet | X | X | 1100 |
| | 3% fabric protector (d)/none | | | | | | |

Examples:

| | | | | | | | |
|---|---|---|---|---|---|---|---|
| 3 | SONTARA 8000/1 mil | dry | dry | dry | dry | dry | 600 |
| | (25 μm) HYTREL 4778 | | | | | | |
| 6 | SONTARA 8000/1 mil | dry | dry | dry | dry | dry | 700 |
| | (25 μm) HYTREL CO-EX | | | | | | |
| 9 | SONTARA 8000/0.6 m | dry | dry | dry | dry | dry | 800 |
| | (15 μm) HYTREL CO-EX | | | | | | |
| 12 | SONTARA 8004/1 mil | dry | dry | dry | dry | dry | 600 |
| | (25 μm) HYTREL 4778 | | | | | | |
| 15 | HDK/0.7 mil (18 μm) | dry | dry | dry | dry | dry | 600 |
| | HYTREL blend | | | | | | |

(a) SONTARA 8000 and 8004 are 1.2 and 1.6 oz/yd² (41 and 54 g/m²), respectively, spunlaced nonwoven polyester fabric available from E. I. du Pont de Nemours and Company, Wilmington DE.
SONTARA 8827 is a 2 oz/yd² (68 g/m²) spunlaced nonwoven fabric having a composition of 55%/45% weight percent wood pulp/polyester available from E. I. du Pont de Nemours and Company, Wilmington DE.

HDK is a 1 oz/yd² (34 g/m²) polyester, powder bonded, non-woven fabric available from H.D.K. Industries Inc., Greenville S.C.

HYTREL 4778 is a copolyether ester thermoplastic elastomer, having a melting point of 208° C., a vicat softening temperature of 175° C., a shore hardness of 47D, and a water absorption of 2.3%. HYTREL 4778 available from E. I. du Pont de Nemours and Company, Wilmington Del.

HYTREL 8206 is a copolyether ester thermoplastic elastomer, having a melting point of 200° C., a vicat softening temperature of 151° C., a shore hardness of 45D, and a water absorption of 30% available from by E. I. du Pont de Nemours and Company, Wilmington Del.

HYTREL Blend is a Du Pont HYTREL film blend No. P18-3892 available from Clopay Corp., Cincinnati Ohio.

HYTREL CO-EX denotes an extrusion coating of first a layer of 80% by weight of HYTREL 8206 on the fabric followed by a 20% by weight of a second extrusion coating layer of HYTREL 4778.

TYVEK HomeWrap is a 1.8 oz/yd² (61 g/m²) spunbond olefin nonwoven fabric available from by E. I. du Pont de Nemours and Company, Wilmington Del.

W/H Housewrap is Weyerhaeuser CHOICE WRAP Housewrap manufactured by Weyerhaeuser, Tacoma Wash.

O-C Housewrap is Owens-Corning PINKWRAP Housewrap manufactured by Owens-Corning, Toledo, Ohio.

The spunbonded polyester (SBPET), a nonwoven fabric with a basis weight of 0.9 oz/yd² (31 g/m²), is available from American Non-wovens, Vernon, Ala.

The spunbonded polypropylene (SBPP), a nonwoven fabric with a basis weight of 0.5 oz/yd² (17 g/m²), is available from ATEX, Gainesville, Ga.

HYTREL G4778 is a thermoplastic polyester elastomer made of polyether-ester block copolymers manufactured by E. I. du Pont de Nemours and Company, Wilmington, Del.

BYNEL 50E631 is an anhydride-modified polypropylene resin manufactured by E. I. du Pont de Nemours and Company, Wilmington, Del.

KC MICROCOOL is a laminate nonwoven fabric available from Kimberly-Clark, Irving, Tex. and believed to be a tri-layer structure with two outside layers of spunbonded polypropylene and a middle layer of microporous polypropylene film made by incorporation of calcium carbonate in the polypropylene film followed by stretching in the machine direction to create the microporous film prior to thermal bonding lamination. Although “microporous”, the KC MICROCOOL fabric acts as a breathable liquid-impermeable underlay, passing the requirements of Test Methods 1 and 2, as shown in Table 1 for Example 16.

(b) By Test Method 1.

(c) Moisture vapor transmission rate, by Test Method 2.

(d) The SONTARA 8827 was pretreated with the indicated amount of a fabric protector emulsion described in U.S Patent No. 5,344,903. The emulsion contained a copolymer of acrylic and methacrylic fluorochemical esters manufactured by E. I. du Pont de Nemours and Company, Wilmington Del.

The results in Table 1 showed the Example breathable liquid-impermeable underlays of the present invention provided liquid water impermeability even under the highest blotting pressures used while providing an adequate MVTR of greater than 100 g/m²/day. Comparative examples failed the blotting test, or, in the case of impermeable thermoplastic films such as Comparative Example C, acted as an undesirable moisture vapor barrier.

What is claimed is:

1. A carpet underlay comprising a composite of a fibrous substrate having opposite first and second planar sides, and at least one film affixed to the first side of said substrate, said underlay impermeable to liquids and permeable to moisture vapor.

2. The underlay of claim 1 wherein the fibrous substrate is a woven or nonwoven fabric or web selected from the group consisting of polyester, poly(trimethylene terephthalate), polyolefin, polyamide, synthetic fibers, natural fibers, bicomponent fibers, cellulosic fibers, wool, cotton, acrylic, jute, and copolymers and blends thereof.

3. The underlay of claim 2 wherein the fibrous substrate is a polyester spun-laced nonwoven fabric.

4. The underlay of claim 1 wherein the film is selected from the group consisting of vulcanized silicone rubber, silicone polymer, polyurethane, polyether ester, polyether amide, polyurethane ester, polyurethane ether, polyvinyl alcohol, and copolymers and blends thereof.

5. The underlay of claim 4 wherein the film is a butylene/poly(alkylene ether) phthalate copolymer.

6. The underlay of claim 1 wherein the film has a first layer and second layer, each of said layers being comprised of a different moisture vapor permeable polymer composition.

7. The underlay of claim 6 wherein one layer of film is a hydrophilic layer and one layer of film is a hydrophobic layer.

8. The underlay of claim 1 wherein the underlay has a minimum moisture vapor transmission rate of 100 g/m² per day.

9. A carpet underlay comprising a composite of a fibrous substrate, an optional control layer affixed to said substrate, a tie layer affixed to said control layer or to said substrate, and a moisture vapor permeable film affixed to said tie layer, said underlay impermeable to liquids and differentially permeable to moisture vapor.

10. The underlay of claim 9 wherein the fibrous substrate is a woven or nonwoven fabric or web selected from the group consisting of polyester, poly(trimethylene terephthalate), polyolefin, polyamide, synthetic fibers, natural fibers, bicomponent fibers, cellulosic fibers, wool, cotton, acrylic, jute, and copolymers and blends thereof.

11. The underlay of claim 9 wherein the optional control layer is a polymer capable of reducing the moisture vapor transmission rate of the composite, said control layer selected from the group consisting of polyethylene, polypropylene or a copolymer or blend thereof.

12. The underlay of claim 9 wherein the tie layer is a copolymer of ethylene co-monomer units and vinyl acetate co-monomer units.

13. The underlay of claim 9 wherein the film is selected from the group consisting of vulcanized silicone rubber, silicone polymer, polyurethane, polyether ester, polyether amide, polyurethane ester, polyurethane ether, polyvinyl alcohol, and copolymers and blends thereof.

14. A tufted pile carpet comprising:
a) a primary backing having a surface tufted with pile yarns and an underside to which a latex has been applied;
b) an optional secondary backing having a surface and an underside, wherein the surface of the secondary backing is adhered to the underside of the primary backing; and
c) an underlay of claim 1, 6, or 9 adjacent to or affixed to the primary or secondary backing.

15. A carpet cushion of a material providing resiliency, support, or noise reduction having opposite first and second planar sides and having adjacent to or affixed to one of said sides an underlay of claim 1, 6, or 9.

16. A process for rendering a carpet or a carpet cushion impermeable to liquids and permeable to moisture vapor comprising placing adjacent to or affixing to an underside of said carpet or said carpet cushion an underlay comprising a composite of a fibrous substrate and at least one film, said underlay impermeable to liquids and permeable to moisture vapor.

17. A process for rendering a carpet or a carpet cushion impermeable to liquids and permeable to moisture vapor comprising placing adjacent to or affixing to an underside of said carpet or said carpet cushion an underlay comprising a composite of a fibrous substrate, an optional control layer affixed to said substrate, a tie layer affixed to said control layer or to said substrate, and a moisture vapor permeable film affixed to said tie layer, said underlay impermeable to liquids and differentially permeable to moisture vapor.

18. The process of claim 16 or 17 wherein the underlay has a minimum moisture vapor transmission rate of 100 g/m² per day.
